(19) United States
(12) Patent Application Publication
(10) Pub. No.: US 2020/0302897 A1
(43) Pub. Date: Sep. 24, 2020

(54) BUSINESS CARD MANAGEMENT SYSTEM AND CARD CASE

(71) Applicant: ORYLAB INC., Tokyo (JP)

(72) Inventor: Kentaro YOSHIFUJI, Tokyo (JP)

(73) Assignee: ORYLAB INC., Tokyo (JP)

(21) Appl. No.: 16/893,387

(22) Filed: Jun. 4, 2020

Related U.S. Application Data
(63) Continuation of application No. PCT/JP2018/044769, filed on Dec. 5, 2018.

(30) Foreign Application Priority Data
Dec. 7, 2017 (JP) 2017-234935

(51) Int. Cl. G09G 5/22; G06K 9/46; G06K 9/62; G06Q 10/10; G06F 16/53; B42F 7/14

(52) U.S. Cl. CPC G09G 5/22; G06K 9/46; G06K 9/6215; G09G 2354/00; G06F 16/53; B42F 7/14; G06K 2209/01; G06Q 10/109

(57) ABSTRACT

The present invention enables information associated with a person who provided a business card to be acquired when a user stores the business card in a business card case. A business card management system according to an aspect of the present invention includes a business card case, and a business card management apparatus, wherein the business card case includes an accommodation part that is capable of accommodating a plurality of business cards in a stacked manner, and a reading part that reads an image of a business card accommodated in the accommodation part, and the business card management apparatus causes a display to display additional information related to character information acquired from the image of the business card read by the reading part.

### CROSS-REFERENCE TO RELATED APPLICATIONS

The present application is a continuation application of International Application number PCT/JP2018/044769, filed on Dec. 5, 2018, which claims priority under 35 U.S.C § 119(a) to Japanese Patent Application No. 2017-234935, filed on Dec. 7, 2017. The contents of this application are incorporated herein by reference in their entirety.

### BACKGROUND

There is a custom of exchanging business cards between people who meet for the first time in business or the like. If one person exchanges business cards with many people and sees them later, it may be difficult to remember people from whom he/she received the business cards.

Japanese Unexamined Patent Application Publication No. 2003-283895 discloses a business card case that includes a camera for capturing images of a business card and a face of the other party when exchanging business cards and can record and display the images of the face and the business card in association with each other. According to the technique described in Japanese Unexamined Patent Application Publication No. 2003-283895, a person can record the face of the other party when exchanging business cards, which may help the person to remember the person later.

However, the technique described in Japanese Unexamined Patent Application Publication No. 2003-283895 only records the images of the business card and the face of the person in association with each other, and does not acquire content of the business card. It is convenient not only to record the business card but also to acquire information related to the other party when exchanging business cards.

### SUMMARY

The present invention focuses on these points, and an object of the present invention is to provide a business card management system and a business card case which can acquire information related to a person who provided a business card when the business card is accommodated in the business card case.

A business card management system of the first aspect of the present invention includes a business card case, and a display control device, wherein the business card case includes an accommodation part that is capable of accommodating a plurality of business cards in a stacked manner, and a reading part that reads an image of a business card accommodated in the accommodation part, and the display control device causes a display to display additional information related to character information acquired from the image of the business card read by the reading part.

A business card case of the second aspect of the present invention includes an accommodation part that accommodates a plurality of business cards in a stacked manner, a reading part that reads an image of the business card accommodated in the accommodation part, and a display part that displays additional information related to character information acquired from the image of the business card read by the reading part.

A method for displaying information of the third aspect of the present invention includes the steps of reading an image of a business card accommodated in a business card case including an accommodation part that accommodates a plurality of business cards in a stacked manner, and displaying additional information related to character information acquired from the image of the business card read in the reading.

### BRIEF DESCRIPTION OF THE DRAWINGS

FIG. 1 is a schematic diagram of a business card management system according to the first embodiment.

FIG. 2A and FIG. 2B show an appearance of a business card case according to the first embodiment.

FIG. 3 is a cross-sectional view of the business card case according to the first embodiment accommodating business cards.

FIG. 4 is a block diagram showing a functional configuration of the business card case according to the first embodiment.

FIG. 5 is a block diagram of a business card management apparatus according to the first embodiment.

FIG. 6 is a front view of a display part of the business card case displaying character information.

FIG. 7A and FIG. 7B are front views of the display part of the business card case displaying history information and common point information.

FIG. 8 is a schematic diagram of a message sent by the business card management apparatus according to the first embodiment to a person who provided the business card.

FIG. 9 is a sequence diagram of a business card management method performed by the business card management system according to the first embodiment.

FIG. 10 is a schematic diagram of the business card management system according to a variation of the first embodiment.

FIG. 11 is a schematic diagram of user's profile information stored in a memory.

FIG. 12 is a block diagram of the business card management apparatus according to the second embodiment.

FIG. 13 shows an image of a business card of a user stored in the memory.

FIG. 14A and FIG. 14B are front views of the display part of the business card case displaying the character information and additional information.

FIG. 15 is a flowchart illustrating the business card management method performed by the business card management apparatus according to the second embodiment.

### DETAILED DESCRIPTION OF THE INVENTION

Hereinafter, the present invention will be described through exemplary embodiments of the present invention, but the following exemplary embodiments do not limit the invention according to the claims, and not all of the combinations of features described in the exemplary embodiments are necessarily essential to the solution means of the invention.

### The First Embodiment

### [An Outline of a Business Card Management System S]

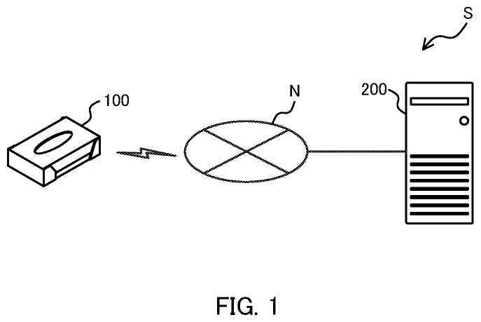

FIG. 1 is a schematic diagram of a business card management system S according to the present embodiment. The business card management system S includes a business card case 100 and a business card management apparatus 200. The business card management system S may include other devices such as a server, a terminal, and the like.

The business card case 100 is a business card case (also referred to as a card case) that can accommodate a plurality of business cards in a stacked manner. The business card case 100 captures an image of a surface of an accommodated business card, and displays information relating to the captured business card. Further, the business card case 100 is configured to be able to perform wireless communication with a network N.

The business card management apparatus 200 is a computer that manages information on the business card. Further, the business card management apparatus 200 is a display control device that performs control for acquiring character information from an image of the business card, acquiring additional information related to the acquired character information, and displaying the information on a display part of the business card case 100. The character information is information written on the business card, and includes personal information such as his/her name, telephone number, e-mail address, and a name of an organization to which he/she belongs. The additional information is information related to the character information acquired from the image of the business card, and includes, for example, at least one of i) history information indicating the character information stored in the past related to the character information acquired this time, and ii) common point information indicating a common point between the character information and a user of the business card case 100. The business card management apparatus 200 is connected to the network N by a wired or wireless connection.

### [An Appearance of the Business Card Case 100]

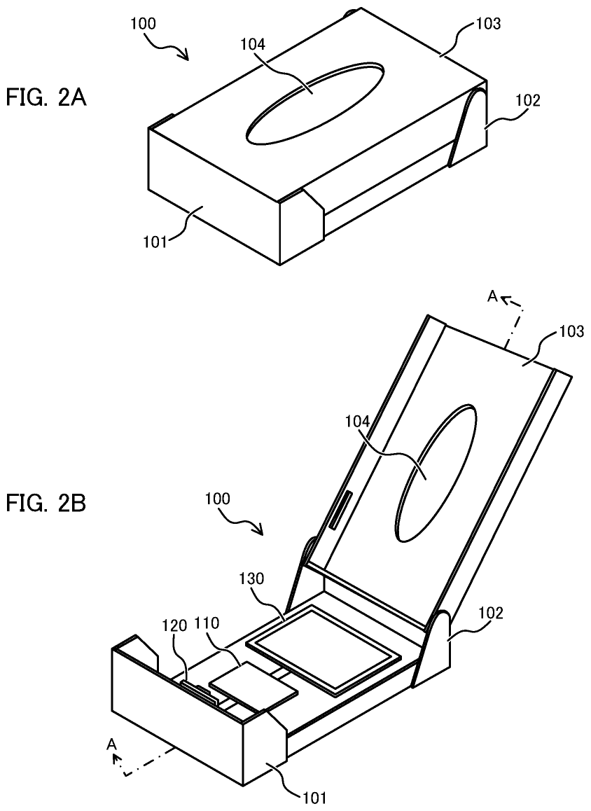

FIGS. 2A and 2B show an appearance of the business card case 100 according to the present embodiment. FIG. 2A shows the business card case 100 in a closed state, and FIG. 2B shows the business card case 100 in an open state. The business card case 100 includes a housing 101 and an accommodation part 103.

A support part 102 for rotatably supporting the accommodation part 103 is provided on the housing 101. Rotating the accommodation part 103 with the support part 102 as a base point allows the business card case 100 to switch between the open state and the closed state. If the business card case 100 is in the closed state, the accommodation part 103 is supported substantially parallel (0 degrees) to the housing 101. If the business card case 100 is in the open state, the accommodation part 103 is supported at a predetermined angle of greater than 0 degrees and less than 180 degrees with respect to the housing 101.

The accommodation part 103 functions as a lid of the housing 101, and can accommodate a plurality of business cards in a stacked manner. The accommodation part 103 is provided with a through-hole 104 for allowing communication between the inside and the outside of the business card case 100.

The housing 101 supports a control part 110, a reading part 120, and a display part 130. The reading part 120 includes an image capturing device such as a camera and a scanner for capturing and reading the business card accommodated in the accommodation part 103. The reading part 120 passes captured content as an image to the control part 110.

The business card case 100 may further include a light emitting part such as LEDs for irradiating the business card accommodated in the accommodation part 103 with infrared rays (infrared light). In this instance, the reading part 120 includes an image capturing device (e.g., an infrared camera) capable of receiving the infrared rays. The light emitting part irradiates the business card with the infrared rays at a time when the reading part 120 reads the business card. Thus, the reading part 120 can read the business card with high accuracy even in a dark environment where sufficient light quantity cannot be obtained, or in an environment where it is too bright to read characters on the business card correctly.

The display part 130 includes a display device such as a liquid crystal display and an organic electroluminescent (OLED: Organic Light Emitting Diode) display, which displays information relating to the business card read by the reading part 120. The display part 130 may be configured to function as an operation part by using a touch screen capable of detecting a position of contact by a user.

The control part 110 is electrically connected to the reading part 120 and the display part 130 to control their operation. The function of the control part 110 will be described later.

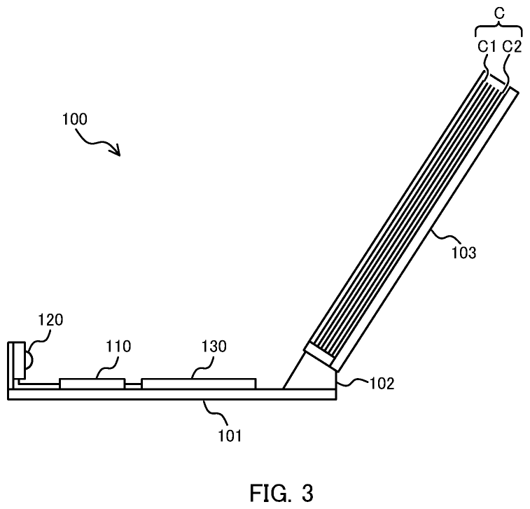

FIG. 3 shows an A-A-line cross section of the business card case 100 according to the present embodiment accommodating business cards C. When the accommodation part 103 that is parallel to the housing 101, which means the business card case 100 is in the closed state, is assumed to be 0 degrees, the accommodation part 103 is supported at a predetermined angle of greater than 0 degrees and less than 180 degrees with respect to the housing 101 when the business card case 100 is in the open state.

If the business card accommodated in the accommodation part 103 is supported at a steep angle with respect to the housing 101, the reading part 120 may acquire a greatly distorted image and the character information may not be correctly acquired from the image. Therefore, in order to improve the accuracy of acquiring the character information from the image of the business card, the accommodation part 103 is preferably supported at a predetermined angle of 90 degrees or more and 150 degrees or less with respect to the housing 101.

The user operates a button (not shown in figures) or the display part 130, which is a touch screen, to cause the reading part 120 to capture the business card. The reading part 120 captures a business card C1 set at the innermost side (i.e., the side closest to the reading part 120) of the business cards C accommodated in the accommodation part 103, and passes the captured content as an image to the control part 110. The display part 130 then displays the information relating to the business card C1 read by the reading part 120.

With such a configuration, the business card case 100 can read the business card accommodated in the accommodation part 103, and therefore, the information on the business card can be acquired by the user just putting the business card received from the other party into the business card case 100. As a result, there is no need to put a business card in or out for reading.

A business card C2 set at the outermost side (i.e., the side closest to the accommodation part 103) of the business cards C accommodated in the accommodation part 103 faces the through-hole 104 on the accommodation part 103. The user can take out the business card C2 from the accommodation part 103 by touching and sliding the business card C2 accommodated in the accommodation part 103 via the through-hole 104.

The user accommodates his/her business card in the accommodation part 103. When exchanging business cards, the user takes out the business card C2 set at the outermost side as his/her own business card and gives the card to the other party, and puts the business card received from the other party at the innermost side of the business cards C accommodated in the accommodation part 103. As a result, the business card C1 at the innermost side is the business card of the other party, and can be read by the reading part 120.

At this time, one of the user's business cards is taken out from the accommodation part 103 when one business card of the other party is added to the accommodation part 103. That is, the accommodation part 103 is configured to be shared by the user's business card and the business card of the other party. As a result, the distance between the reading part 120 and the business card C1 (i.e., the business card of the other party) at the innermost side is kept constant, and so it is possible to suppress a change in the condition under which the image is captured, thereby improving the accuracy of acquiring the character information from the image.

### [A Configuration of the Business Card Case 100]

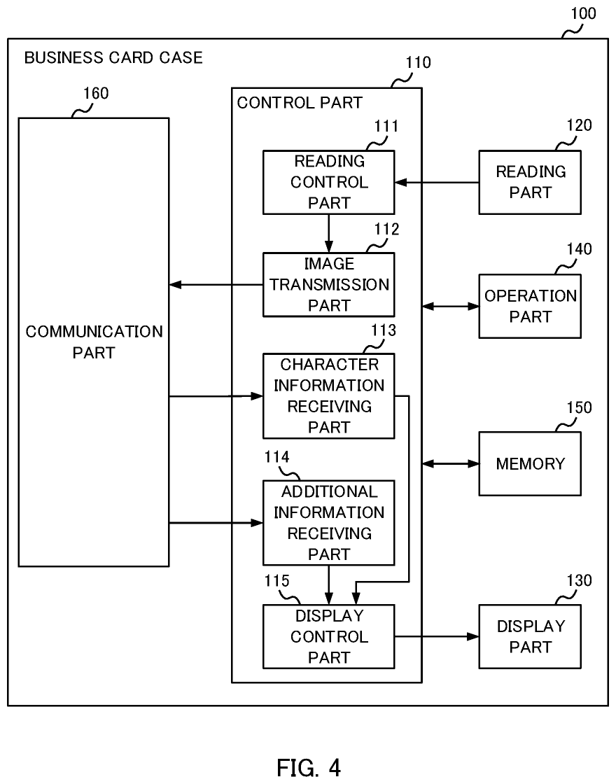

FIG. 4 is a block diagram showing a functional configuration of the business card case 100 according to the present embodiment. In FIG. 4, arrows indicate main data flows, and there may be data flows not shown in FIG. 4. In FIG. 4, each block shows a functional unit configuration, not a hardware (device) unit configuration. As such, the blocks shown in FIG. 4 may be implemented in a single device or separately in multiple devices. Transfer of data between blocks may be through any means, such as a data bus, network, portable storage medium, or the like.

The business card case 100 includes an operation part 140, a memory 150, and a communication part 160 in addition to the control part 110, the reading part 120, and the display part 130 described above.

The communication part 160 is a communication interface for communicating with the business card management apparatus 200 via the network N. The communication part 160 includes an antenna, a processor, a circuit, and the like for performing radio communication. The communication part 160 acquires data by performing a predetermined process on a communication signal received from the outside, and inputs the acquired data to the control part 110. Further, the communication part 160 performs a predetermined process on the data inputted from the control part 110 to generate a communication signal, and transmits the generated communication signal to the outside.

The operation part 140 includes members such as a button, a switch, and a dial for receiving an operation by a user. The display part 130 and the operation part 140 may be integrally formed by using a touch screen capable of detecting a position of contact by the user as the display part 130.

The memory 150 is a storage medium including a Read Only Memory (ROM), a Random Access Memory (RAM), and the like. The memory 150 previously stores programs to be executed by the control part 110.

The control part 110 is a processor such as a Central Processing Unit (CPU), and functions as a reading control part 111, an image transmission part 112, a character information receiving part 113, an additional information receiving part 114, and a display control part 115 by executing the programs stored in the memory 150. At least some of the functions of the control part 110 may be performed by an electronic circuit. Further, at least some of the functions of the control part 110 may be executed by the programs executed via the network.

The reading control part 111 controls the reading part 120 to capture and read a business card. The reading control part 111 acquires the content captured by the reading part 120 as an image, and stores the image in the memory 150. The image transmission part 112 retrieves the image of the business card read by the reading part 120 from the memory 150, and transmits the image to the business card management apparatus 200 via the communication part 160.

The character information receiving part 113 receives the character information, read from the image of the business card in the business card management apparatus 200, via the communication part 160, and stores the character information in the memory 150. The additional information receiving part 114 receives the additional information, related to the character information read from the images of the business card, via the communication part 160, and stores the additional information in the memory 150. The content of the character information and the additional information will be described later.

The display control part 115 controls the display part 130 to display the character information and the additional information received by the character information receiving part 113 and the additional information receiving part 114.

The business card case 100 according to the present embodiment is not limited to the specific configuration shown in FIG. 4. The business card case 100 is not limited to one device, and may be configured by connecting two or more separated devices by wire or wirelessly.

### [A Configuration of the Business Card Management Device 200]

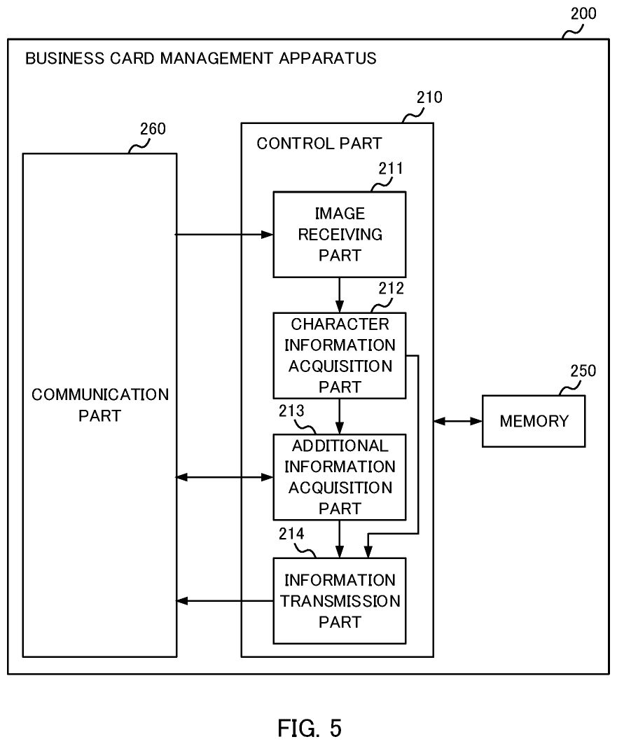

FIG. 5 is a block diagram of the business card management apparatus 200 according to the present embodiment. In FIG. 5, arrows indicate main data flows, and there may be data flows not shown in FIG. 5. In FIG. 5, each block shows a functional unit configuration, not a hardware (device) unit configuration. As such, the blocks shown in FIG. 5 may be implemented in a single device or separately in multiple devices. Transfer of data between blocks may be through any means, such as a data bus, network, portable storage medium, or the like.

The business card management apparatus 200 includes a control part 210, a memory 250, and a communication part 260. The communication part 260 is a communication interface for communicating with the business card case 100 via the network N. The communication part 260 includes a processor, a connector, a circuit, and the like for performing communication. The communication part 260 acquires data by performing a predetermined process on a communication signal received from the outside, and inputs the acquired data to the control part 210. Further, the communication part 260 performs a predetermined process on the data inputted from the control part 210 to generate a communication signal, and transmits the generated communication signal to the outside.

The memory 250 is a storage medium including a ROM, a RAM, a hard disk drive, and the like. The memory 250 previously stores programs to be executed by the control part 210.

The control part 210 is a processor such as a CPU, and functions as an image receiving part 211, a character information acquisition part 212, an additional information acquisition part 213, and an information transmission part 214 by executing the programs stored in the memory 250. At least some of the functions of the control part 210 may be performed by an electronic circuit. Further, at least some of the functions of the control part 210 may be executed by the programs executed via the network.

The image receiving part 211 receives the image of the business card transmitted from the business card case 100 via the communication part 260, and stores the image in the memory 250. The character information acquisition part 212 retrieves the image of the business card received by the image receiving part 211 from the memory 250, and acquires the character information showing characters written on the business card from the retrieved image.

Specifically, first, the character data acquisition part 212 corrects the image retrieved from the memory 250 so that the characters can be recognized. In the business card case 100 according to the present embodiment, the reading part 120 captures an image of a business card accommodated in the accommodation part 103 from an oblique direction, and so a trapezoidal distortion occurs. As described with reference to FIG. 3, the accommodation part 103 is supported at the predetermined angle with respect to the housing 101, and the distance between the business card accommodated in the accommodation part 103 and the reading part 120 is kept constant. The angle and distance corresponding to the configuration of the business card case 100 are previously set in the business card management apparatus 200. The character information acquisition part 212 performs a trapezoidal correction on the image of the business card, on the basis of the angle of the accommodation part 103 with respect to the housing 101 and the distance between the business card accommodated in the accommodation part 103 and the reading part 120.

As described above, in the present embodiment, the image of the business card can be corrected by using the known angle and distance, so that the character information can be acquired with higher accuracy than in a case where the correction is performed when the imaging condition is undefined. The character information acquisition part 212 may omit the correction if the character information can be acquired without performing the correction.

The character information acquisition part 212 then acquires the character information from the corrected image of the business card, and stores the acquired character information in the memory 250 together with an acquisition time (registration time). Known character recognition techniques, such as an optical character reader (OCR), can be used to acquire the character information from the image.

The character information includes personal information such as his/her name, telephone number, e-mail address, and a name of an organization to which he/she belongs (i.e., a name of a corporation, a group, a school, or the like) written on the business card. Further, if information such as career information, identification information on a social networking service (SNS), and the like is written on the business card in addition to the personal information, the character information acquisition part 212 may acquire such information as the character information.

The control part 110 of the business card case 100 may acquire the character information from the image of the business card. In this case, the character information acquisition part 212 acquires the character information by receiving the character information from the business card case 100.

If the character information acquisition part 212 succeeded in acquiring the character information, the additional information acquisition part 213 acquires the additional information related to the character information on the basis of the character information acquired by the character information acquisition part 212.

The additional information includes at least one of i) history information indicating the character information stored in the past related to the character information acquired this time by the character information acquisition part 212 and ii) common point information indicating a common point between the character information acquired this time by the character information acquisition part 212 and the user of the business card case 100.

As the history information, the additional information acquisition part 213 acquires, from the character information stored in the memory 250 in the past, the past character information including at least a portion (e.g., a name of an organization to which he/she belongs or a domain name of an e-mail address) of the character information that the character information acquisition part 212 acquires this time. The history information should include a time when past character information was stored (registered) in the memory 250.

As the common point information, the additional information acquisition part 213 detects and acquires a common point between attributes of the person who provided the business card and the user of the business card case 100, on the basis of the character information acquired by the character information acquisition part 212. The attribute for which a common point is detected includes, for example, a scholastic career, an occupational career, a hobby, a place of residence, and the like. The attribute of the user of the business card case 100 is previously set to the business card management apparatus 200.

The additional information acquisition part 213 may acquire the attribute of the person who provided the business card from the character information acquired by the character information acquisition part 212 in order to detect the common point. There may be a business card including an attribute such as a career and a hobby of a person who provided the business card in some cases. In this situation, the additional information acquisition part 213 acquires the attribute of the person who provided the business card from the character information acquired by the character information acquisition part 212. The additional information acquisition part 213 then acquires the common point information by detecting at least a corresponding portion between the attribute of the person who provided the business card acquired from the character information and the attribute of the user of the business card 100 which is previously set.

In order to detect the common point, the additional information acquisition part 213 may acquire the attribute of the person who provided the business card from an external system such as an SNS. In this instance, the additional information acquisition part 213 acquires the attribute of the person who provided the business card from the SNS by searching the SNS using the personal information (e.g., his/her name and a name of an organization to which he/she belongs) included in the character information acquired by the character information acquisition part 212. If the business card contains SNS identification information (such as his/her account name), the additional information acquisition part 213 may search through the SNS using the identification information.

The additional information acquisition part 213 acquires the common point information by detecting at least a corresponding portion between the attribute of the person who provided the business card acquired from an external system such as an SNS and the attribute of the user of the business card 100 that is previously set.

The information transmission part 214 transmits the character information and the additional information acquired by the character information acquisition part 212 and the additional information acquisition part 213 to the business card case 100 via the communication part 260. Further, if the character information acquisition part 212 failed to acquire the character information, the information transmission part 214 transmits information indicating the failure to acquire the character information to the business card case 100 via the communication part 260.

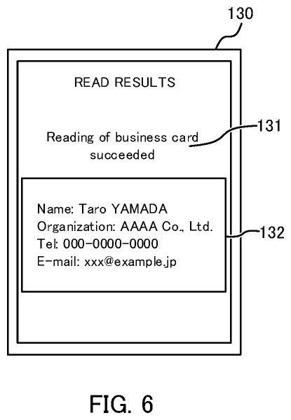

FIG. 6 is a front view of the display part 130 of the business card case 100 displaying the character information. When receiving the character information acquired by the character information acquisition part 212 from the business card management apparatus 200, the business card case 100 displays received character information 132 and a message 131 indicating that the reading was successful on the display part 130. When receiving information indicating that the character information failed to be acquired from the business card management apparatus 200, the business card case 100 may display a message indicating that the reading failed on the display part 130.

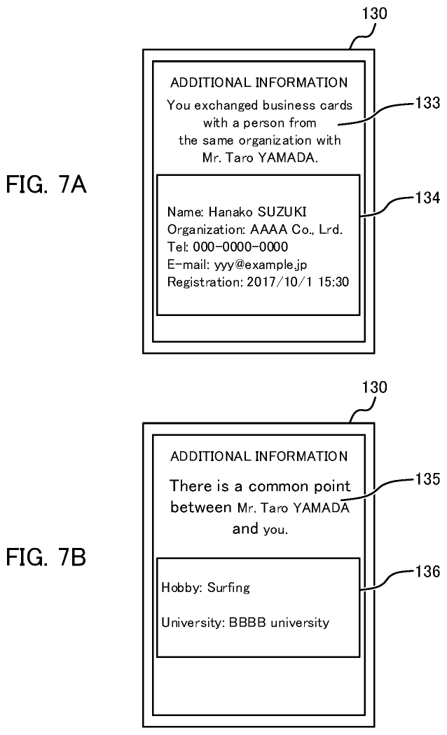

FIG. 7A is a front view of the display part 130 of the business card case 100 displaying the history information. When the history information is received from the business card management apparatus 200 as the additional information, the business card case 100 displays received history information 134 and the message 133 indicating that the history information exists. As a result, the user of the business card case 100 can know that the user has previously received a business card from a person belonging to the same organization as the person who provided the business card read this time.

If someone belonging to the same organization as the user of the business card case 100 has already received the business card from the person who provided the business card read this time, the business card case 100 may display this fact on the display part 130. In this situation, the memory 250 of the business card management apparatus 200 stores the character information of the business card, read by a plurality of business card cases 100 owned by a plurality of users, in association with the user having the business card case 100 that has already read said business card. In addition, the memory 250 pre-stores the personal information, such as his/her name, a name of an organization to which he/she belongs, and the like, of the user who have the business card case 100.

If the character information acquired by the character information acquisition part 212 this time has already been stored in the memory 250, the additional information acquisition part 213 of the business card management apparatus 200 specifies another user (i.e., someone who received the business card from the same person in the past) associated with said character information. The additional information acquisition part 213 acquires the personal information of the specified other user and the personal information of the user of the business card case 100 from the memory 250.

If the personal information acquired from the memory 250 indicates that the user of the business card case 100 and the other user belong to the same organization (the names of a corporation, department, or the like are the same), the additional information acquisition part 213 passes the personal information of the other user to the information transmission part 214 as the history information. The information transmission part 214 transmits the history information acquired by the additional information acquisition part 213 to the business card case 100 via the communication part 260.

If the personal information of the other user is received, as the history information, from the business card management apparatus 200, the business card case 100 displays the received personal information of the other user on the display part 130. Thus, the user of the business card 100 can know that the other user, belonging to the same organization as the user of the business card 100, has already received the business card from the person who provided the business card read this time.

FIG. 7B is a front view of the display part 130 of the business card case 100 displaying the common point information. If the common point information is received from the business card management apparatus 200 as the additional information, the business card case 100 displays received common point information 136 and a message 135 indicating that there is a common point. This allows the user of the business card case 100 to know the content of the common point if there is a common point between the person who provided the business card read this time and the user.

If the additional information acquisition part 213 acquires both the history information and the common point information as the additional information, the business card case 100 may switch the display on the display part 130 between the history information and the common point information according to the user's operation or the time passage.

In addition, if an e-mail address of the person who provided the business card is included in the character information acquired by the character information acquisition part 212, the information transmission part 214 sends a message including the personal information of the user of the business card 100 to the e-mail address. The information transmission part 214 may send the message by using a Short Message Service (SMS) addressed to a telephone number or an SNS message addressed to SNS identification information instead of sending an e-mail.

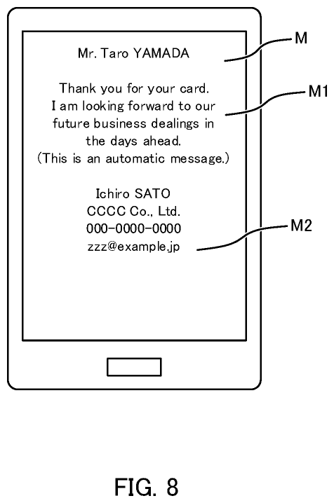

FIG. 8 is a schematic diagram of a message M sent by the business card management apparatus 200 according to the present embodiment to the person who provided the business card. The message M is received by a communication terminal owned by the person who provided the business card and is displayed on a communication terminal display. When the message M is received from the business card management apparatus 200, the communication terminal owned by the person who provided the business card displays personal information M2 of the user of the business card case 100 and a message M1 indicating that the message M has been sent from the user of the business card case 100. This allows the person who provided the business card to receive the information of the user of the business card case 100 in an electronic data state, thereby eliminating efforts required for registering the business card of the user of the business card case 100.

The business card management apparatus 200 according to the present embodiment is not limited to the specific configuration shown in FIG. 5. The business card management apparatus 200 is not limited to one apparatus, and may be configured by connecting two or more separated apparatuses connected by wire or wirelessly.

Each function of the business card management apparatus 200 may be built in the business card case 100. In this instance, the control part 110 of the business card case 100 functions as a display control device for acquiring the character information on the basis of the image of the business card and acquiring the additional information on the basis of the character information, and displaying the acquired additional information on the display part 130 without transmitting/receiving the image of the business card.

### [A Sequence of a Business Card Management Method]

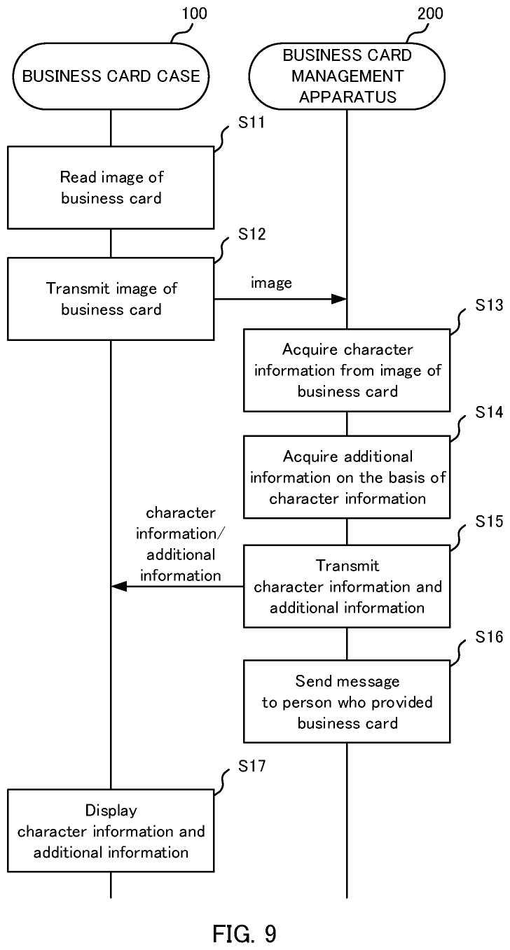

FIG. 9 is a sequence diagram of a business card management method performed by the business card management system S according to the present embodiment. In the business card case 100, the reading control part 111 first controls the reading part 120 to capture and read the business card accommodated in the business card case 100 (step S11). The reading control part 111 acquires the content captured by the reading part 120 as an image, and stores the image in the memory 150. The image transmission part 112 retrieves the image of the business card read by the reading part 120 in step S11 from the memory 150, and transmits the image to the business card management apparatus 200 via the communication part 160 (step S12).

In the business card management apparatus 200, the image receiving part 211 receives the image of the business card transmitted from the business card case 100 via the communication part 260, and stores the image in the memory 250. The character information acquisition part 212 retrieves the image of the business card received by the image receiving part 211 from the memory 250, and acquires the character information indicating characters written on the business card from the retrieved image (step S13).

The additional information acquisition part 213 acquires the additional information related to the character information on the basis of the character information acquired by the character information acquisition part 212 in step S13 (step S14). The information transmission part 214 transmits the character information and the additional information acquired by the character information acquisition part 212 and the additional information acquisition part 213 in steps S13 to S14 to the business card case 100 via the communication part 260 (step S15).

If the character information acquired by the character information acquisition part 212 in step S13 includes destination such as an e-mail address of the person who provided the business card, the information transmission part 214 sends a message including personal information of the user of the business card case 100 to that destination (step S16).

In the business card case 100, the character information receiving part 113 receives the character information transmitted from the business card management apparatus 200 via the communication part 160, and stores the character information in the memory 150. The additional information receiving part 114 receives the additional information transmitted from the business card management apparatus 200 via the communication part 160, and stores the additional information in the memory 150. The display control part 115 controls the display part 130 to display the character information and the additional information received by the character information receiving part 113 and the additional information receiving part 114 (step S17).

### The First Variation of the Present Embodiment

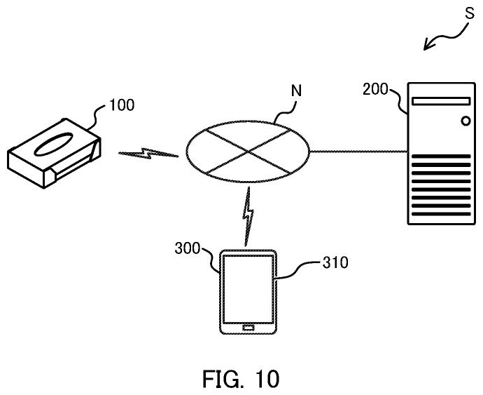

In the business card management system S described above, the display part 130 provided to the business card case 100 displays various types of information, but a display device external to the business card case 100 may display the various types of information. FIG. 10 is a schematic diagram of the business card management system S according to a variation of the present embodiment. The business card management system S includes, in addition to the business card case 100 and the business card management apparatus 200 described above, a communication terminal 300 as a display device external to the business card case 100.

The communication terminal 300 is a communication device capable of communicating with the business card case 100 and the business card management apparatus 200, and is, for example, a portable terminal such as a smartphone or a personal computer. The communication terminal 300 has a display part 310 that includes a display device such as a liquid crystal display, an organic electroluminescent display, or the like. The communication terminal 300 may communicate with the business card case 100 or the business card management apparatus 200 via the network N, or may communicate with the business card case 100 or the business card management apparatus 200 via a short-range radio network such as Bluetooth.

The business card management apparatus 200 is pre-associated with the communication terminal 300 owned by the user of the business card case 100. The information transmission part 214 of the business card management apparatus 200 transmits the character information acquired by the character information acquisition part 212 and the additional information acquired by the additional information acquisition part 213 to the communication terminal 300. The communication terminal 300 then displays the same information as the information shown in FIGS. 6 and 7 on the display part 310. With such a configuration, the business card case 100 does not need the display part thereby reducing the weight.

### The Second Variation of the Present Embodiment

In the above-described business card management system S, the additional information acquisition part 213 acquires the common point information on the basis of the character information written on the business card or the information from the external system such as the SNS, but may acquire the common point information on the basis of the profile information of each user previously registered in the business card management system S.

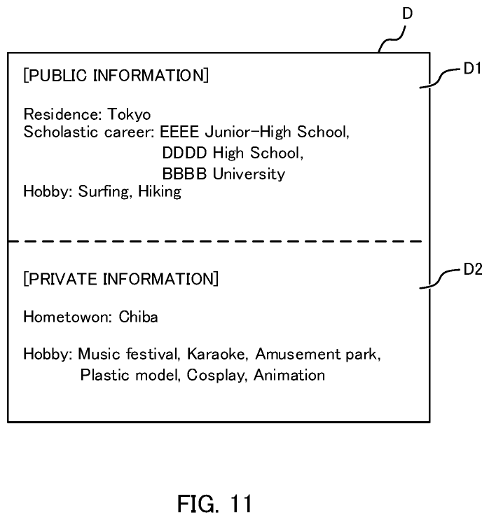

FIG. 11 is a schematic diagram of profile information D of the user stored in the memory 250. The profile information D is shown in character string for visibility in FIG. 11, but each piece of data may be recorded in any format such as character string data, numeric data, and binary data. The profile information D may be recorded as a database or as a list enumerating data.

The profile information D includes public information D1 and private information D2. The public information D1 is information about the user disclosed to the other party regardless of the profile information D of the other party who exchanged the business cards. The private information D2 is information about the user disclosed to the other party only if the private information D2 has a common point with the profile information D of the other party who exchanged the business cards. For example, the user sets information that may be disclosed regardless of the other party in the public information D1, and sets information that should be disclosed only to another party that has a common interest or the like in the private information D2.

The profile information D is inputted by the user and is previously stored in the memory 250 in association with a user ID that is identification information for identifying the user. The user ID is pre-associated with the character information (his/her name, telephone number, e-mail address, and the like) written on the user's business card. The user ID may be the character information written on the user's business card. The profile information D may be inputted to the business card case 100 or to a communication terminal associated with the business card case 100.

The additional information acquisition part 213 acquires the additional information on the basis of (i) the profile information of the user (a first user) of the business card case 100 stored in the memory 250 and (ii) the profile information of the user (a second user who provided the business card to the first user) associated with the character information acquired this time by the character information acquisition part 212.

Specifically, the additional information acquisition part 213 acquires the profile information of the first user from the memory 250 using the user ID set in the business card case 100. Further, the additional information acquisition part 213 acquires the profile information of the second user from the memory 250 using the user ID associated with the character information acquired this time by the character information acquisition part 212.

Among the private information indicated by the profile information of the second user, the additional information acquisition part 213 acquires, as the common point information, the private information having a common point with the private information indicated by the profile information of the first user. For example, if the private information of the first user includes “animation” and the private information of the second user includes “animation,” the additional information acquisition part 213 acquires “animation” as the common point information. The additional information acquisition part 213 may acquire not only identical private information between the users but also similar private information between the users as the common point information.

The additional information acquisition part 213 may acquire the common point information only when the business cards are exchanged between the users. The time (registration time) of acquiring the character information stored in the memory 250 corresponds to the time at which the business card case 100 reads the business card. Therefore, the additional information acquisition part 213 determines, on the basis of the time of acquiring the character information stored in the memory 250, that the first user and the second user exchanged the business cards when the difference between the time at which the first user's business card case 100 reads the second user's business card and the time at which the second user's business card case 100 reads the first user's business card is within a predetermined time (for example, within 5 minutes).

If it is determined that the first user and the second user exchanged the business cards, the additional information acquisition part 213 acquires the private information having a common point between the first user and the second user as the common point information. As a result, even if a third party acquires the business card of the user, the private information of the user is not disclosed to the third party unless the business card case 100 of the user reads the business card of the third party, thereby preventing the private information of the user from being unintentionally browsed.

The additional information acquisition part 213 may acquire the private information if the operations of the first user and the second user, when having the business card cases 100 read the business cards, each satisfy a predetermined condition. In this case, each of the business card cases 100 of the first user and the second user has, as the operation part 140, a button or a switch for performing an operation for permitting or not permitting provision of the private information. The first user and the second user perform a predetermined operation on the button or the switch when they cause the reading part 120 of the business card case 100 to read the business card if they intend to allow the private information to be provided to the person who provided the business card. Alternatively, the first user and the second user perform the predetermined operation on the button or the switch when they cause the reading part 120 of the business card case 100 to read the business card if they do not intend to allow the private information to be provided to the person who provided the business card. The timing for performing the predetermined operation may be before reading the business card, while reading the business card, or after reading the business card.

The business card cases 100 transmit the content of operations, performed by the first user and the second user on the operation parts 140 while the reading parts 120 are reading the business cards, to the business card management apparatus 200 via the communication parts 160. The additional information acquisition part 213 acquires the private information having a common point between the first user and the second user if the operations received from the business card case 100 of the first user and the business card case 100 of the second user satisfy the predetermined condition (for example, if an operation permitting the provision of the private information is performed, or an operation not permitting the provision of the private information is not performed). Thus, the business card management system S can disclose the private information common to two users only if the two users who have exchanged the business cards permit the provision of the private information.

The additional information acquisition part 213 acquires the common point information acquired in this manner as the additional information. The additional information acquisition part 213 may acquire the public information indicated by the profile information as the additional information, in addition to the common point information.

The information transmission part 214 transmits the additional information acquired by the additional information acquisition part 213 to the business card case 100 via the communication part 260. The business card case 100 displays the common point information on the display part 130 as shown in FIG. 7B on the basis of the additional information received from the business card management apparatus 200.

According to the business card management system S of the present variation, setting a hobby and the like that the user does not want to disclose to an unspecified other party as the private information enables disclosing the user's private information only to the other party who has set his/her private information having a common point with the user's private information. As a result, the user can smoothly communicate with the other party while restricting the disclosure of the profile information of the user. Further, if the user has many hobbies and the like, disclosing all of them to the other party may cause excessive information, but the business card management system S can suppress the amount of information disclosed between the users because it discloses only a portion of the private information common to the user and the other party.

### Effects of the First Embodiment

In the business card management system S according to the present embodiment, the business card case 100 can read the business card accommodated in the accommodation part 103, thereby eliminating putting in and taking out of the business card for reading. Therefore, the labor required for registering the information relating to the business card can be reduced.

In addition, the business card management apparatus 200 can display not only the character information written on the business card but also the additional information related to the character information on the business card case 100 or an external display part. For example, if the user of the business card case 100 received, in the past, a business card from a person belonging to the same organization as the person who provided the business card read this time, the user can obtain the history information indicating this fact as the additional information. For example, if there is a common point between the person who provided the business card read this time and the user of the business card 100, the user can obtain the common point information indicating the content of the common point as the additional information. As a result, the user of the business card case 100 can immediately know the information about the other party with whom he/she has exchanged the business cards, thereby facilitating communication.

### The Second Embodiment

The business card management system S according to the first embodiment acquires the character information by performing the character recognition process on the image of the business card, whereas the business card management system S according to the present embodiment acquires the character information by matching the image of the business card with an image that is previously registered. Differences from the first embodiment will be mainly described below.

### [A Configuration of the Business Card Management Apparatus 200]

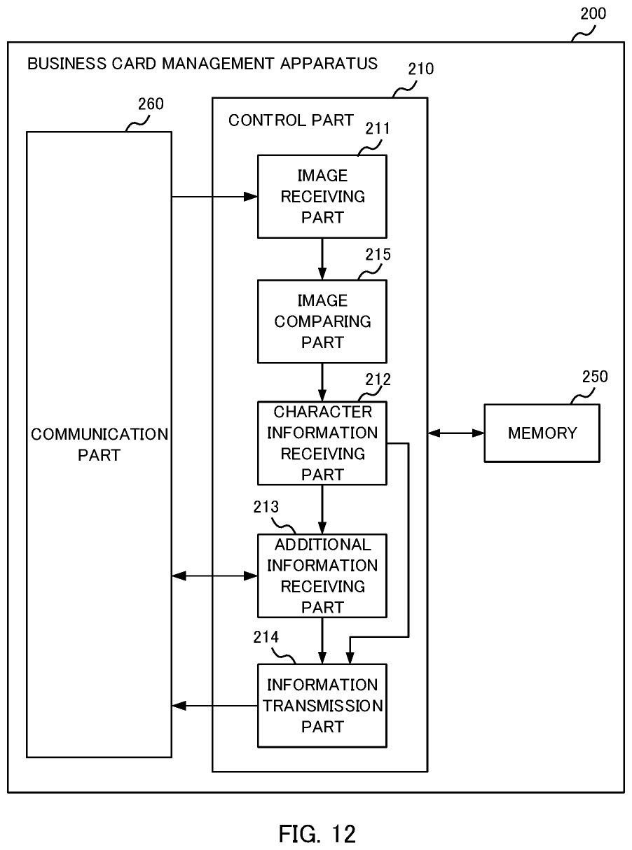

FIG. 12 is a block diagram of the business card management apparatus 200 according to the present embodiment. The control part 210 of the business card management apparatus 200 according to the present embodiment further includes an image comparing part 215 in addition to the configuration shown in FIG. 5. The memory 250 of the business card management apparatus 200 pre-stores the character information written on the business card of each user having the business card case 100, the image (registered image) of the business card of the each user, and the profile information of the each user in association with each user.

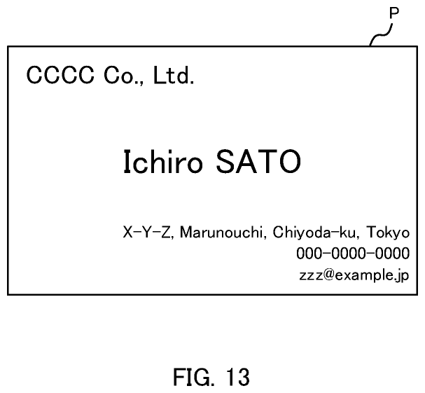

FIG. 13 shows an image of a business card P of the user stored in the memory 250. The image of the business card P may be captured by the user's business card case 100, or may be captured by the user's communication terminal or camera. The image of the business card P of the user includes the character information such as his/her name, address, telephone number, e-mail address, and a name of an organization to which he/she belongs. The memory 250 may store, instead of the image P, features (such as contours) calculated on the basis of the image P.

The user captures the image of the business card using the business card case 100, and then the image receiving part 211 receives the image of the business card transmitted from the business card case 100 via the communication part 260, and stores the image in the memory 250. The image comparing part 215 retrieves the image (captured image) of the business card received by the image receiving part 211 from the memory 250.

The image comparing part 215 compares the captured image with each of the registered images stored in the memory 250, and specifies a registered image similar to the captured image. Specifically, the image comparing part 215 calculates the similarity indicating the degree of similarity between the captured image and the registered images. For example, the image comparing part 215 calculates the degree of similarity on the basis of the difference between each pixel value of the captured image and each pixel value of the registered images. The image comparing part 215 may calculate a feature amount of the captured image and the feature amounts of the registered images, and calculate the similarity on the basis of the calculated feature amounts. Then, the image comparing part 215 specifies a registered image whose similarity satisfies a predetermined condition (for example, the similarity is equal to or greater than a predetermined value) as a registered image similar to the captured image.

Alternatively, the image comparing part 215 may specify the registered image similar to the captured image on the basis of learning data previously obtained by machine-learning the images of the business cards.

If the image comparing part 215 succeeded in specifying a registered image similar to the captured image, the character information acquisition part 212 acquires, from the memory 250, the character information of the user (the person who provided the business card) associated with the registered image similar to the captured image specified by the image comparing part 215. The character information acquisition part 212 stores the acquired character information in the memory 250 together with the acquisition time (registration time). As described above, if the person who provided the business card uses the business card management system S according to the present embodiment, the image comparing part 215 and the character information acquisition part 212 specify the character information written on the business card by making a comparison to the image of the business card, and so the character information can be acquired with high accuracy without being affected by the character recognition error.

If the image comparing part 215 failed to specify a registered image similar to the captured image, the character information acquisition part 212 acquires the character information by performing the character recognition process on the captured image, as in the first embodiment. The character information acquisition part 212 stores the acquired character information in the memory 250 together with the acquisition time (registration time). Thus, even if the person who provided the business card does not use the business card management system S according to the present embodiment, the character information acquisition part 212 can acquire the character information written on the business card by using the character recognition.

If the image comparing part 215 succeeded in specifying a registered image similar to the captured image, the additional information acquisition part 213 acquires the additional information on the basis of the profile information shown in FIG. 11, as in the second variation of the first embodiment. Specifically, the additional information acquisition part 213 acquires the profile information of the user (the first user) associated with the business card case 100 from the memory 250 using the user ID set in the business card case 100. Further, the additional information acquisition part 213 acquires the profile information of the user (i.e., the second user associated with the provided business card) associated with the registered image that is similar to the captured image from the memory 250, using the user ID specified on the basis of the registered image similar to the captured image. In the present embodiment, the user ID is pre-associated with the image of the user's business card.

The additional information acquisition part 213 acquires the additional information on the basis of the profile information of the first user and the profile information of the second user. In the present embodiment, the profile information includes introduction information in addition to the public information and the private information shown in FIG. 11. The introduction information is information indicating an introduction of the user by other users. The introduction information is shown by a character string, a score, or the like. The other users set the introduction information about the user when they exchange business cards with the user. The introduction information is inputted by the other users who exchanged the business cards with the user and stored in the memory 250.

The additional information acquisition part 213 acquires the public information and the introduction information indicated by the user's profile information associated with the registered image similar to the captured image. Further, the additional information acquisition part 213 acquires the private information common between the first user and the second user as the common point information. The additional information acquisition part 213 uses, for example, the same methods as those of the second variation of the first embodiment to acquire the common point information.

The information transmission part 214 transmits the character information acquired by the character information acquisition part 212 to the business card case 100 via the communication part 260. Further, the information transmission part 214 transmits the public information, the common point information, and the introduction information acquired by the additional information acquisition part 213 as the additional information to the business card case 100 via the communication part 260.

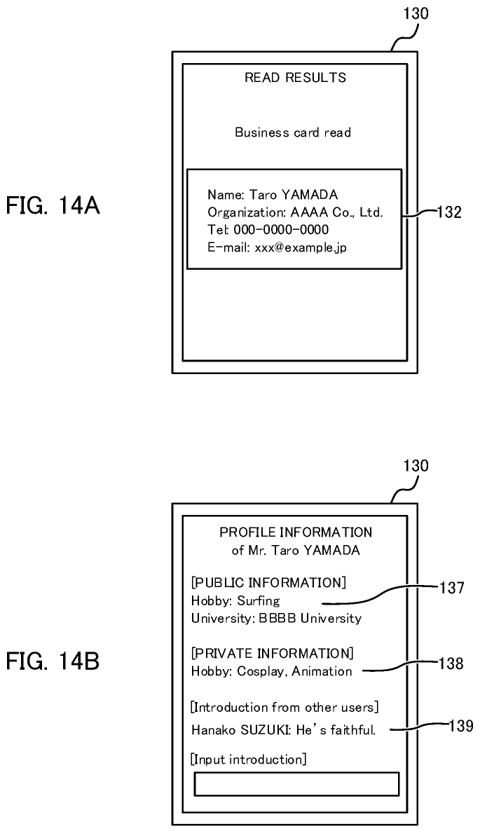

FIG. 14A is a front view of the display part 130 of the business card case 100 displaying the character information. The business card case 100 displays the character information 132 received from the business card management apparatus 200 on the display part 130. The business card case 100 transitions to the screen shown in FIG. 14B if the user performs a predetermined operation (for example, pressing a button) using the operation part 140 while displaying the screen shown in FIG. 14A.

FIG. 14B is a front view of the display part 130 of the business card case 100 displaying the additional information. The business card case 100 causes the display part 130 to display public information 137, common point information 138, and introduction information 139 indicated by the additional information received from the business card management apparatus 200. Thus, the user of the business card case 100 can refer to the profile information of the person who provided the business card read this time.

By referring to the common point information 138 of the person who provided the business card, the user can know that the person who provided the business card has the same interest and the like with the user thereby facilitating a conversation when exchanging the business cards. Further, the user can know that the person who provided the business card has a connection with the other user by referring to the introduction information 139 of the person who provided the business card made by said other user.

Further, the business card case 100 may accept an input of the introduction information from the user. In this case, the business card case 100 causes the display part 130 to display an input field of the introduction information as shown in FIG. 14B. The business card case 100 may accept the input of the introduction information via the operation part 140 of the business card case 100, or may accept the input of the introduction information via the communication terminal associated with the business card case 100.

The business card case 100 transmits the introduction information inputted by the user to the business card management apparatus 200 via the communication part 160. The business card management apparatus 200 adds the introduction information received from the business card case 100 to the profile information about the person who provided the business card, and stores the profile information in the memory 250.

### [A Flow of the Business Card Management Method]

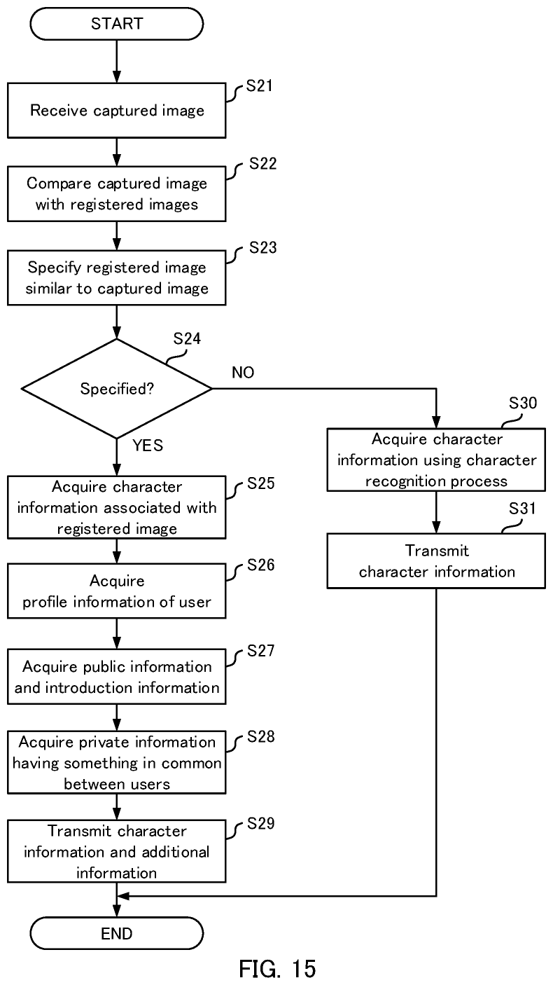

FIG. 15 is a flowchart illustrating a business card management method performed by the business card management apparatus 200 according to the present embodiment. When the user captures the image of the business card using the business card case 100, the image receiving part 211 receives the image (captured image) of the business card transmitted from the business card case 100 via the communication part 260 (S21), and stores the image in the memory 250.

The image comparing part 215 compares the captured image received by the image receiving part 211 with the registered images stored in the memory 250 (step S22). The image comparing part 215 specifies a registered image similar to the captured image (step S23).

If the image comparing part 215 succeeded in specifying a registered image similar to the captured image (YES in step S24), the character information acquisition part 212 acquires the character information of the user (the person who provided the business card) associated with the registered image similar to the captured image specified by the image comparing part 215 from the memory 250 (step S25).

The additional information acquisition part 213 acquires the profile information of the user of the business card case 100 and the profile information of the user associated with the registered image similar to the captured image from the memory 250 (step S26). The additional information acquisition part 213 then acquires the additional information on the basis of the profile information of the user of the business card 100 and the profile information of the user associated with the registered image similar to the captured image.

Specifically, the additional information acquisition part 213 acquires the public information and the introduction information indicated by the profile information of the user associated with the registered image similar to the captured image (step S27). In addition, among the private information indicated by the profile information of the user associated with the registered image similar to the captured image, the additional information acquisition part 213 acquires the private information common to the private information indicated by the profile information of the user of the business card 100 as the common point information (step S28).

The information transmission part 214 transmits the character information and the additional information acquired by the character information acquisition part 212 and the additional information acquisition part 213 to the business card case 100 via the communication part 260 (step S29).

If the image comparing part 215 failed to specify a registered image similar to the captured image (NO in step S24), the character information acquisition part 212 acquires the character information by performing the character recognition process on the captured image (step S30). The information transmission part 214 transmits the character information acquired by the character information acquisition part 212 to the business card case 100 via the communication part 260 (step S31).

### Effects of the Second Embodiment

According to the business card management system S of the present embodiment, if the person who provided the business card uses the business card management system S, the business card management apparatus 200 specifies the character information written on the business card by making a comparison to the image of the business card, and so the character information can be acquired with high accuracy without being affected by the character recognition error.

The present invention is explained on the basis of the exemplary embodiments. The technical scope of the present invention is not limited to the scope explained in the above embodiments and it is possible to make various changes and modifications within the scope of the invention. For example, the specific embodiments of the distribution and integration of the apparatus are not limited to the above embodiments, all or part thereof, can be configured with any unit which is functionally or physically dispersed or integrated. Further, new exemplary embodiments generated by arbitrary combinations of them are included in the exemplary embodiments of the present invention. Further, effects of the new exemplary embodiments brought by the combinations also have the effects of the original exemplary embodiments.

Processors of the business card case 100 and the business card management apparatus 200 are the core of each step (process) included in the business card management method shown in FIGS. 9 and 15. That is, the processors of the business card case 100 and the business card management apparatus 200 execute the business card management method shown in FIGS. 9 and 15 by i) retrieving the program for executing the business card management method shown in FIGS. 9 and 15 from the memories and ii) executing the program to control the parts of the business card case 100 and the business card management device 200. The steps included in the business card management method shown in FIGS. 9 and 15 may be partially omitted, the order of the steps may be changed, or a plurality of steps may be performed in parallel.

What is claimed is:

1. A business card management system, comprising:
a business card case; and
a display control device, wherein
the business card case includes:
an accommodation part that is capable of accommodating a plurality of business cards in a stacked manner, and
a reading part that reads an image of a business card accommodated in the accommodation part, and
the display control device causes a display to display additional information related to character information acquired from the image of the business card read by the reading part.

2. The business card management system according to claim 1, wherein
the display control device includes:
a processor that acquires the character information from the image of the business card and acquires the additional information on the basis of the acquired character information.

3. The business card management system according to claim 2, wherein
the display control device further includes a memory that stores the image of the business card and the character information in association with each other, and
the processor compares the image of the business card read by the reading part with the images of the business cards stored in the memory, and acquires the character information associated with the image of a business card stored in the memory that is similar to the image of the business card read by the reading part.

4. The business card management system according to claim 3, wherein
the processor acquires the character information by performing a character recognition process on the image of the business card read by the reading part if an image of a business card similar to the image of the business card read by the reading part is not stored in the memory.

5. The business card management system according to claim 2, wherein
the processor acquires, as the additional information, history information indicating previously acquired character information related to the character information acquired from the image of the business card.

6. The business card management system according to claim 5, wherein
the display control device further includes a memory that stores the previously acquired character information, and
the processor acquires, as the history information, the previously acquired character information including at least a portion of the character information acquired from the image of the business card among the previously acquired character information stored in the memory.

7. The business card management system according to claim 5, wherein
the processor acquires the history information indicating previously acquired character information from an image of a business card of a person different from a person who provided the business card read by the reading part.

8. The business card management system according to claim 2, wherein
the processor acquires, as the additional information, common point information indicating a common point between the character information acquired from the image of the business card and the user of the business card case.

9. The business card management system according to claim 8, wherein
if at least a portion of an attribute acquired on the basis of the character information acquired from the image of the business card matches the attribute of the user of the business card case, the processor acquires the matching portion as the common point information.

10. The business card management system according to claim 2, wherein
the display control device further includes a memory that stores profile information of a first user associated with the business card case and profile information of a second user associated with the business card read by the reading part, and
the processor acquires, as common point information, information common to the profile information of the first user among the profile information of the second user.

11. The business card management system according to claim 10, wherein
the processor acquires the common point information if a difference between a time at which the business card case of the first user reads the business card of the second user and a time at which the business card case of the second user reads the business card of the first user is within a predetermined time.

12. The business card management system according to claim 10, wherein
the common point information is acquired if operations performed by the first user and the second user to the business card cases each satisfy a predetermined condition when the reading parts read the images of the business cards.

13. The business card management system according to claim 2, wherein
the processor sends a message to a destination included in the character information.

14. The business card management system according to claim 1, wherein
the display control device displays the additional information on a display provided in the business card case or on a display provided in a communication terminal capable of communicating with the business card case.

15. A business card case, comprising:
an accommodation part that accommodates a plurality of business cards in a stacked manner;
a reading part that reads an image of the business card accommodated in the accommodation part; and
a display that displays additional information related to character information acquired from the image of the business card read by the reading part.

16. The business card case according to claim 15, further comprising:
a transmission part that transmits the image to an external device; and
a receiving part that receives the character information and the additional information from the external device.

17. A method for displaying information, comprising the steps of:
reading an image of a business card accommodated in a business card case including an accommodation part that accommodates a plurality of business cards in a stacked manner; and
displaying additional information related to character information acquired from the image of the business card read in the reading.
